(19) United States
(12) Patent Application Publication
(10) Pub. No.: US 2008/0213553 A1
(43) Pub. Date: Sep. 4, 2008

(54) Privacy Securing Film

(75) Inventor: Byoung-Woo Hwang, Gyeonggi-do (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: Shehwa P & C Co., Ltd.,, Gyeonggi-do (KR)

(21) Appl. No.: 10/592,205

(22) PCT Filed: Feb. 28, 2005
(86) PCT No.: PCT/KR2005/000552

§ 371 Date: Sep. 8, 2006

(30) Foreign Application Priority Data
Mar. 25, 2004 (KR) 10-2004-0020202
Sep. 23, 2004 (KR) 10-2004-0076262

(51) Int. Cl. B32B 7/02; B32B 27/00; B32B 27/40; B32B 27/30

(52) U.S. Cl. 428/215; 428/213

(57) ABSTRACT

The present invention relates to a privacy securing film, and more particularly, to a privacy securing film having a louver film, wherein the louver film is manufactured through a process including the steps of i) alternately laminating and thermo-compressing transparent film layers and opaque adhesive ink layers, and ii) cutting the thermo-compressed, laminated film perpendicularly to or at a certain angle with respect to the surface thereof such that the thickness of the louver film is in a range of 2 to 30 times the thickness of the transparent film, and a hard coat layer is provided on at least one outermost face of the privacy securing film. The privacy securing film of the present invention has a simplified structure, can be fabricated through a simple manufacturing process, can significantly reduce the creation of a ghost image, and has excellent radio-shielding effects, as compared with conventional ones. The privacy securing film is useful since it can protect private lives of users and also protect the users against harmful electromagnetic waves upon application thereof to a variety of screens of display devices such as CRTs, LCDs and cellular phones.

### TECHNICAL FIELD

The present invention relates to a privacy securing film, and more particularly, to a privacy securing film having a louver film, wherein the louver film is manufactured through a process including the steps of i) alternately laminating and thermo-compressing transparent film layers and opaque adhesive ink layers, and ii) cutting the thermo-compressed, laminated film perpendicularly to or at a certain angle with respect to the surface thereof such that the thickness of the louver film is in a range of 2 to 30 times the thickness of the transparent film, and a hard coat layer is provided on at least one outermost face of the privacy securing film.

### BACKGROUND ART

A privacy securing film is also referred to as a light control film or the like. The demand for the privacy securing film has increased according to a tendency in taking serious view on each individual private life. Accordingly, many studies on the privacy securing film have been made, mainly for application to a window blind and the like. For example, U.S. Pat. No. 2,053,175 to E. Astima discloses a method of manufacturing a louver film by alternately laminating transparent materials and opaque materials and cutting the laminate vertically. In addition, U.S. Pat. No. 2,689,387 to Carr, W. P. et al. discloses a plastic blind, which is manufactured by alternately arranging transparent films and adhesive optical shielding films, adhering them to one another and then cutting the laminate vertically. Further, U.S. Pat. No. 3,524,789 to Olsen, F. O. et al. discloses a method of manufacturing a privacy securing film by slicing a stacked billet. Recently, with the development of display devices such as CRTs and LCDs, a securing film for protecting individual privacy, i.e., for not showing the contents displayed on a display device to others, has been increasingly demanded. However, a conventional privacy securing film produces a ghost image, due to a variation in the refraction index of a plastic part at the interface between a transparent portion and an opaque portion, thereby causing a fatigue or tiredness to an operator. Therefore, recent researches on privacy securing films have been focused on reduction in the creation of a ghost image that was a problem in the related art. To reduce the creation of the ghost image, International Publication No. WO 92/11549 discloses a light control film employing a multi-layered louver that comprises high optical absorption layers containing a relatively high content of carbon black and low optical absorption layers containing a relatively low content of carbon black.

### DISCLOSURE OF INVENTION

### Technical Problem

However, the conventional privacy securing films in the aforementioned documents employ complicated louver structures, which lead to complicated manufacturing processes and high production costs.

Therefore, an object of the invention is to provide a privacy securing film having a louver film, which can be manufactured through a simplified and economically efficient process, while reducing eyestrain through a decrease in surface reflection and also minimizing the creation of a ghost image.

Another object of the invention is to provide a privacy securing film, which contain a radio-shielding component, thereby protecting users from harmful electromagnetic waves emitted from display devices.

### Technical Solution

In order to achieve these objects, the present invention provides a privacy securing film having a louver film, wherein the louver film is manufactured through a process including the steps of i) alternately laminating and thermo-compressing transparent film layers and opaque adhesive ink layers, and ii) cutting the thermo-compressed, laminated film perpendicularly to or at a certain angle with respect to the surface thereof such that the thickness of the louver film is in a range of 2 to 30 times the thickness of the transparent film; and a hard coat layer is provided on at least one outermost face of the privacy securing film.

In the privacy securing film of the present invention, the material of the transparent film may be polyvinyl chloride (PVC), polyethylene terephthalate (PET), polyacrylate, polymethyl methacrylate, polyurethane, polycarbonate, polyethylene, polypropylene, cellulose acetate butylate (CAB), or a copolymer thereof.

Further, the transparent film and the opaque adhesive ink layer of the louver film may have a thickness of 0.01 to 0.2 mm and 0.001 to 0.05 mm, respectively.

Moreover, the opaque adhesive ink may contain a synthetic resin and a colorant.

The synthetic resin may be ethylene-vinyl acetate (EVA), polyvinyl alcohol (PVA), polyvinyl chloride (PVC), polyethylene terephthalate (PET), polyacrylate, polymethyl methacrylate, polyurethane, polycarbonate, polyethylene, polypropylene, cellulose acetate butylate (CAB), polyisocyanate, polypropylene oxide, hydroxyethyl acrylate, hydroxyethyl methacrylate, propylene oxide monoacrylate, or a copolymer thereof.

Furthermore, the louver film may be provided with an antistatic layer on at least one face thereof; wherein the antistatic layer is formed of a metallic thin film or synthetic resin containing a metallic component or a conductive polymer.

In addition, a non-gloss coat layer may be provided on at least one face of the hard coat layer such that the privacy securing film has a surface glossiness of less than 85 unit.

The process of manufacturing the louver film may further comprise the step of laminating a radio-shielding coat layer after the transparent film and the opaque adhesive ink layer are laminated, wherein the radio-shielding coat layer is formed of a composition comprising 60 to 80 wt % of carbon paste and 0.01 to 0.1 wt % of fine metallic particles.

The radio-shielding coat layer may be formed in such a way that the composition is repeatedly coated with a thickness of 0.01 to 0.015 mm one to six times.

The metallic particles may be nanosized particles of at least one selected from the group consisting of silver, gold, and copper.

### BRIEF DESCRIPTION OF DRAWINGS

FIG. 1 is a perspective view of a privacy securing film manufactured according to an embodiment of the present invention.

FIG. 2 is a sectional view of the privacy securing film manufactured according to the embodiment of the invention.

FIG. 3 is a partially exploded perspective view illustrating a process for manufacturing a louver film provided in the privacy securing film of the present invention.

FIG. 4 is a partially exploded perspective view of a louver film with a radio-shielding coat layer.

### BEST MODE FOR CARRYING OUT THE INVENTION

Hereinafter, the present invention will be described in detail.

A privacy securing film of the present invention includes a louver film. The louver film is manufactured through a process comprising the steps of i) alternately laminating and thermo-compressing transparent film layers and opaque adhesive ink layers, ii) cutting the thermo-compressed, laminated film perpendicularly to or at a certain angle with respect to the surface thereof such that the thickness of the louver film is in a range of 2 to 30 times the thickness of the transparent film layer. The method of manufacturing the louver film is similar to those disclosed in U.S. Pat. No. 2,053,173 to E. Astima or U.S. Pat. No. 2,689,387 to Carr, W. P. at al. However, there is difference therebetween in that the louver film provided in the privacy securing film of the present invention employs an opaque adhesive ink and is manufactured through thermo compression.

As for the material of the transparent film layers provided in the privacy securing film, both known synthetic and natural resins may be used so far as they have a desired light transmittance when manufactured in the form of a film. The synthetic resins are desirable in view of economical efficiency and processability. Preferred examples of the resins to be used as the material of the transparent film layers include polyvinyl chloride (PVC), polyethylene terephthalate (PET), polyacrylate, polymethyl methacrylate, polyurethane, polycarbonate, polyethylene, polypropylene, cellulose acetate butylate (CAB), and a copolymer thereof.

The opaque adhesive ink, which is used when the louver film of the privacy securing film of the present invention is manufactured, contains a synthetic resin and a colorant. The synthetic resin may comprise a well-known synthetic resin that can be used in an adhesive ink. Preferred examples of the resin include ethylene-vinylacetate (EVA), polyvinyl alcohol (PVA), polyvinyl chloride (PVC), polyethylene terephthalate (PET), polyacrylate, polymethyl methacrylate, polyurethane, polycarbonate, polyethylene, polypropylene, cellulose acetate butylate (CAB), polyisocyanate, polypropylene oxide, hydroxyethyl acrylate, hydroxyethyl methacrylate, propylene oxide monoacrylate, and a copolymer thereof.

The colorant preferably has a high light absorptivity so as to achieve sufficient privacy security in the privacy securing film of the present invention, and may employ a known organic or inorganic pigment or dye. In addition, depending on applications of the privacy securing film of the present invention, a colorant having a slightly low light absorptivity may be used. A louver film that is manufactured using an opaque adhesive ink layer containing a colorant of low light absorptivity may be used, for example, for preventing or reducing reflection on a car windshield. A preferred example of the opaque adhesive ink includes a commercially available hot melt ink, or the like.

The transparent film layer and the opaque adhesive ink layer are alternately laminated and thermo-compressed. Ideally, the thermo compression can be preformed at one time after the laminated film has been formed to have a desired thickness. However, considering thermal conductance, it is preferred that the thermo compression be carried out whenever each of the respective transparent film layers and adhesive ink layers is stacked or the layers are stacked to a certain desired thickness. The thickness of the film layers suitable for performing the thermo compression is preferably 1 to 5 mm, more preferably 2 to 4 mm. The thermo compression is carried out, preferably, at a temperature of 110 to 150° C. under a compression pressure of 30 to 70 Mpa for 3 to 10 minutes, and a cooling process for 10 to 20 minutes is preformed 3 to 5 times repeatedly. In order to prevent creation of pores between the films, it is preferred that a vacuum state be established before and/or during the thermo compression.

The resin contained in the opaque adhesive ink is diffused into some of the adjacent transparent film layers during thermo compression to combine the opaque adhesive ink layers with the transparent film layers, which also allows a part of the colorant of high light absorptivity to be diffused into the transparent film layers along with the resin. The privacy securing film having the louver film, which uses the opaque adhesive ink and is thermo-compressed, according to the invention described above reduces significantly the creation of a ghost image that is a problem in a conventional privacy securing film. As for the reason of the reduction in the creation of a ghost image, the inventors found that, when the louver film of the privacy securing film of the present invention is manufactured, a part of the opaque adhesive ink is transferred into the transparent film layers during the thermo compression, and thus, changes in physical properties such as reflectivity are caused at the interface between the transparent film layer and the opaque adhesive ink layer, thereby reducing the creation of the ghost image in the privacy securing film of the present invention. The aforementioned International Publication No. WO 92/11549 discloses a multi-layered louver film comprising high optical absorptivity layers having a relatively high concentration of carbon black concentration and low optical absorptivity layers having a relatively low concentration of carbon black. In contrast, the privacy securing film of the present invention can reduce the creation of the ghost image even while it has a simple structure and is manufactured through a simplified manufacturing process.

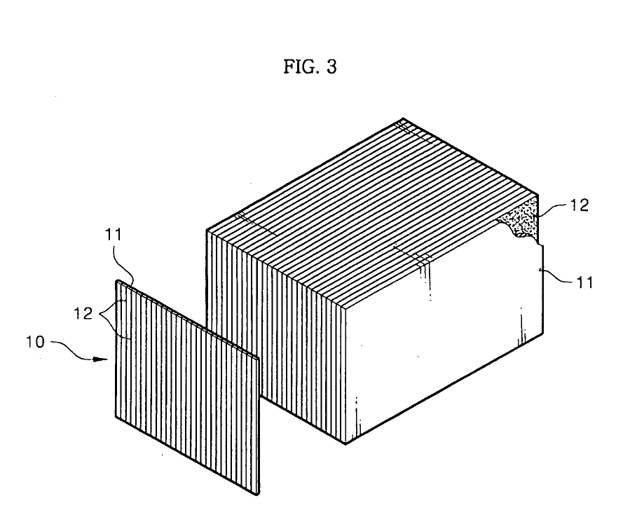

A film laminated to a desired thickness by repeating the alternate lamination of the transparent films and the opaque adhesive ink layers and the thermo compression is cut perpendicularly to or at a certain angle with respect to the surface thereof such that the thickness of the louver film is in a range of 2 to 30 times the thickness of the transparent film layer. If the thickness of the louver film is less than 2 times the thickness of the transparent film layer, the privacy securing effects become insufficient. If it is above 30 times the thickness of the transparent film layer, a viewing angle thereof becomes significantly narrow so that a user comes to feel tired soon. Thus, it is preferred that the thickness of the louver film be in the range of 2 to 30 times the thickness of the transparent film. In addition, the laminate film is cut perpendicularly to or at a certain angle with respect to the surface thereof, wherein the angle may vary depending on applications of the laminate film. That is, if a user's sight line is in parallel with an object with the privacy securing film attached thereto, the laminated film can be cut perpendicularly or approximately perpendicularly to the surface thereof. If the user's sight line is to be at an angle with respect to an object with the privacy securing film attached thereto, it is preferred that the laminated film be cut slantly. FIG. 3 is a partially exploded perspective view illustrating a process for manufacturing the louver film. As can be seen from FIG. 3, the louver film is manufactured by cutting the laminated film, which comprises the alternately stacked transparent films and opaque adhesive ink layers, perpendicularly to the stacking direction.

In the louver film, the thickness of the transparent film layer and the thickness of the opaque adhesive ink layer are preferably 0.01 to 0.2 mm and 0.001 to 0.05 mm, respectively. If the thickness of the transparent film layer is less than 0.01 mm, the boundary thereof with the opaque adhesive ink layer becomes obscure so that the field of view cannot be easily established. If it is above 0.2 mm, the thickness of the louver film required to obtain a viewing angle becomes significantly thick, thus failing to provide a good economical efficiency and also possibly degrading optical properties such as light transmittance. In addition, if the thickness of the opaque adhesive ink layer is less than 0.001 mm, the light shielding capacity becomes deteriorated, thereby failing to achieve the object of the present invention. If it is above 0.05 mm, the opaque ink layer comes to have a visible thickness. This is not desirable because the contents displayed on the screen of a display device may be partially hid by the opaque ink layer, or a user can discern the presence of the opaque ink layer.

With the development of processing technology, the louver film provided in the privacy securing film of the present invention requires less the necessity of polishing. However, the louver film that has been cut as described above may be subjected to an additional polishing process, depending on the surface condition thereof. This is because the optical properties of the louver film may be improved through the polishing process.

The privacy securing film of the present invention may include an antistatic layer on at least one face of the film. The antistatic layer is formed of a metallic thin film or synthetic resin containing a metallic component or a conductive polymer. In a case where the privacy securing film of the present invention is used for a touch screen and the like, it is preferred that the film have an antistatic layer to prevent a user from feeling uneasiness due to static electricity upon touch of the screen. The antistatic layer may be a synthetic resin or a metallic thin film containing a known conductive material, i.e., a metallic component, a conductive polymer or the like. The antistatic layer may be fabricated in the form of a film and then attached to the louver film, or may be formed on the louver film through a chemical vapor deposition (CVD) process.

The privacy securing film of the present invention may be provided with a hard coat layer on at least one outermost face thereof. The role of the hard coat layer is to protect the privacy securing film from a solvent or an external impact, so that the optical properties thereof can be maintained even when used for an extended period of time.

In addition, the privacy securing film is preferably further provided with a non-gloss coat layer attached on the surface of the hard coat layer such that the surface glossiness of the privacy securing film is less than 85 unit. If the surface glossiness becomes above 85 unit upon use of the privacy securing film of the invention, a user may have eyestrain due to optical reflection on the surface thereof, which makes it difficult for the user to see the contents displayed on the screen of a display device. In the present invention, the surface glossiness is measured at a reflection angle of 85 degrees according to the ASTM D 2457 standard. The surface glossiness used herein means a value measured at the reflection angle of 85 degrees according to the ASTM specification.

Moreover, the privacy securing film of the present invention may further comprise a radio-shielding coat layer, which is formed of a composition comprising 60 to 80 wt % of carbon paste and 0.01 to 0.1 wt % of fine metal particles. Upon manufacture of the louver film, the radio-shielding coat layer is stacked after the transparent film layers and the opaque adhesive ink layers are stacked one above another. The radio-shielding coat layer functions to shield electromagnetic waves emitted from the screen of a display device so that a user can be protected from being exposed to detrimental electromagnetic waves. Particularly, the radio-shielding coat layer is preferably used for a CRT or the like that emits a lot of electromagnetic waves. The term “fine metallic particles” means metallic particles having sizes less than microns, which do not affect the reflection index or the like, in order to prevent the creation of a ghost image. Preferably, the sizes thereof are on the order of nanometers ranging from a few nanometers to a few hundreds nanometers. More preferably, the fine metallic particles are nanosized particles of one or more selected from the group consisting of silver, gold, and copper. The fine metallic particles may be used in the form of metal particles as they are, but it is preferred that the fine metallic particles be used in the form of sol or suspension for the purpose of uniform mixing. Although a metal aqueous solution of 50,000 ppm is used to supply the fine metallic particles in an embodiment of the present invention, the present invention is not limited thereto. The radio-shielding coat layer is preferably formed by repeatedly performing coating with the composition to a thickness of 0.01 to 0.015 mm one to six times so as to have a final thickness of 0.04 to 0.06 mm. The reason of the repeated coatings is to achieve uniform distribution of radio-shielding components.

The present invention will be described below in greater detail in connection with preferred embodiments of the present invention. It should be noted that the following embodiments are provided merely for better understanding of the invention and the scope of the present invention is not limited only to the embodiments.

### Embodiment 1

### Manufacture of Privacy Securing Film

A transparent film 11 of 30 cm×40 cm, which is formed of cellulose acetate butylate (CAB) and has a thickness w of 0.1 mm, was coated with an opaque adhesive ink (JELCON AD-HM6™), which contains ethylene-vinyl acetate as a thermoplastic resin and carbon black as a colorant, to establish an ink layer 12 with a thickness of about 0.015 mm, and another transparent film 11 was placed again thereon. Through repeat of this process, the transparent films 11 and the opaque adhesive ink layers 12 were alternately laminated until the thickness of the laminated film became 3 mm. Thereafter, thermo compression was carried out at a temperature of 130° C. under a pressure of 50 Mpa for 5 minutes using a thermo-compressing machine (Model: KH001 available from Korean Engineering, Inc.) and cooling was then performed for 15 minutes. This process was repeatedly performed four times to bond the transparent films and the ink layers of the laminated film. During the cooling process, vacuum was applied to discharge air between the transparent films and the ink layers of the laminated film. The alternate lamination and thermo compression of the transparent films 11 and the opaque adhesive ink layers 12 were carried out repeatedly until the thickness of the laminated film became 30 cm. In the laminated film manufactured as above, the thickness of the opaque adhesive ink layer 12 of the laminated film manufactured as above was 0.01 mm. The laminated film was cut with a thickness of 0.2 mm perpendicularly to the surface thereof, using a cutter (self-manufactured), to thereby form a louver film 10. The cutting thickness corresponds to the thickness of the louver film 10 that is mentioned herein.

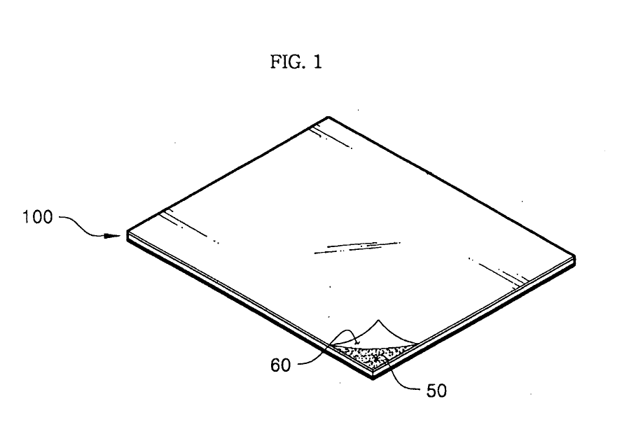

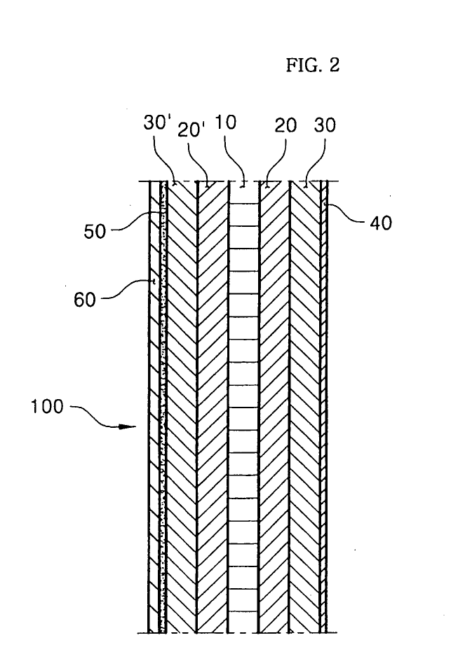

On both faces of the louver film 10 is attached antistatic layers 20 and 20′ each of which was formed of a polyethylene terephthalate (PET) film containing a metallic component for providing electric conductance. In addition, hard coat films 30 and 30′ were attached to outer faces of the antistatic layers 20 and 20′, respectively. A non-gloss. coat layer 40 was attached to one of the hard coat layers 30 and 30′. The other one of the hard coat layers 30 and 30′, which did not have the non-gloss coat layer 40 attached thereon, was coated with an adhesive 50 and a release paper 60 was attached thereon, thereby completing a privacy securing film 100. FIGS. 1 and 2 are a perspective view and a sectional view of the privacy securing film manufactured according to the embodiment of the present invention. As shown in FIG. 1, the privacy securing film of the embodiment of the present invention is configured to be used such that a user removes the release paper 60 from the privacy securing film, which is then attached to the screen of a display device using the adhesive layer 50.

### Embodiment 2

### Characteristics of Privacy Securing Film

Physical properties of the privacy securing film manufactured in Embodiment 1, such as surface glossiness, Rockwell hardness and Abbe's number, were measured and summarized in Table 1 below.

TABLE 1
Physical properties of privacy securing film of Embodiment 1

| Measured Items | Results |
|---|---|
| Surface glossiness¹ | 84 unit |
| Rockwell hardness | 99R scale |
| Abbe's number | 80 ± 3 |

*¹The surface glossiness was measured at a reflection angle of 85° according to the ASTM D 2457 specification.

### Embodiment 3

### Manufacture of Privacy Securing Film Using Louver Film with Radio-Shielding Layer

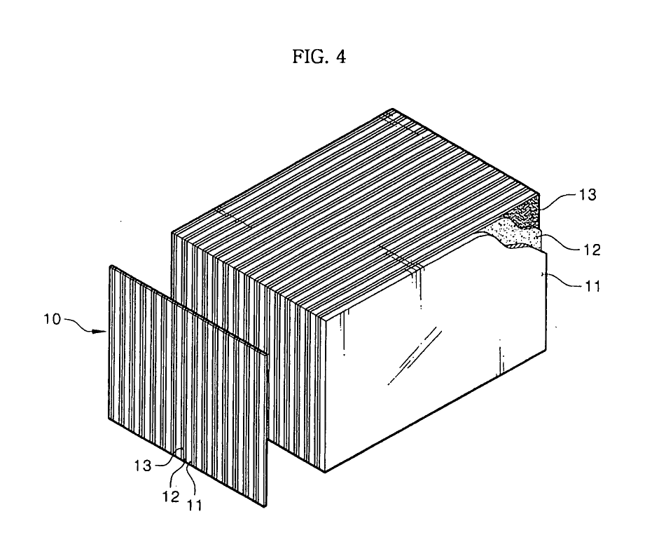

A louver film 10 and then a privacy securing film 100 were manufactured in the same manner as Embodiment 1, excepting that a radio-shielding coat layer 13, which contained 75 wt % of carbon paste and 25 wt % of silver aqueous solution (50,000 ppm) with nanosized silver particles, was additionally laminated to a thickness of 0.05 mm by repeating coating with a thickness of 0.01 to 0.015 mm four times, after an opaque adhesive ink was coated on a transparent film 11 to form an ink layer 12. FIG. 4 is a partially exploded perspective view of the louver film having the radio-shielding coat layer. As shown in FIG. 4, the louver film 10 of this embodiment used for the privacy securing film 100 of the present invention has a structure in which the transparent film 11, the opaque adhesive ink layer 12 and the radio-shielding coat layer 13 were stacked repeatedly in the described order.

### Embodiment 4

### Radio-Shielding Test

The privacy securing film manufactured in Embodiment 3 was tested in order to confirm the radio-shielding effects thereof. The test was carried out in such a manner that an electromagnetic wave was incident on the privacy securing film of Embodiment 3 in a direction perpendicular thereto, while varying the frequency of the electromagnetic wave. At this time, radio transmittance was measured to thereby evaluate the radio-shielding effects. As the results of the test, it was found that the privacy securing film of Embodiment 3 shielded 55 dB, i.e., 99% or more of the electromagnetic wave, over a frequency bandwidth of 30 MHz to 1 GHz.

### INDUSTRIAL APPLICABILITY

As described above, the privacy securing film of the present invention has advantages in that it has a simplified structure, can be manufactured through a simple manufacturing process, and can significantly reduce the creation of a ghost image, as compared with conventional ones. The privacy securing film can be applied to a variety of screens of display devices such as CRTs, LCDs and cellular phones to thereby protect private lives of users and also protect the users against harmful electromagnetic waves by means of a radio-shielding component.

It is intended that the embodiments of the present invention described above should not be construed as limiting the technical spirit of the present invention. The scope of the present invention is defined only by the appended claims. Those skilled in the art can make various changes and modifications thereto without departing from the spirit. Therefore, various changes and modifications obvious to those skilled in the art will fall within the scope of the present invention.

1. A privacy securing film having a louver film, wherein the louver film is manufactured through a process including the steps of i) alternately laminating and thermo-compressing transparent film layers and opaque adhesive ink layers, and ii) cutting the thermo-compressed, laminated film perpendicularly to or at a certain angle with respect to the surface thereof such that the thickness of the louver film is in a range of 2 to 30 times the thickness of the transparent film; and a hard coat layer is provided on at least one outermost face of the privacy securing film.

2. The privacy securing film as claimed in claim 1, wherein the transparent film and the opaque adhesive ink layer of the louver film have a thickness of 0.01 to 0.2 mm and 0.001 to 0.05 mm, respectively.

3. The privacy securing film as claimed in claim 1, wherein the material of the transparent film is polyvinyl chloride (PVC), polyethylene terephthalate (PET), polyacrylate, polymethyl methacrylate, polyurethane, polycarbonate, polyethylene, polypropylene, cellulose acetate butylate (CAB), or a copolymer thereof.

4. The privacy securing film as claimed in claim 1, wherein the opaque adhesive ink contains a synthetic resin and a colorant.

5. The privacy securing film as claimed in claim 4, wherein the synthetic resin is ethylene-vinyl acetate (EVA), polyvinyl alcohol (PVA), polyvinyl chloride (PVC), polyethylene terephthalate (PET), polyacrylate, polymethyl methacrylate, polyurethane, polycarbonate, polyethylene, polypropylene, cellulose acetate butylate (CAB), polyisocyanate, polypropylene oxide, hydroxyethyl acrylate, hydroxyethyl methacrylate, propylene oxide monoacrylate, or a copolymer thereof.

6. The privacy securing film as claimed in claim 1, wherein the louver film is provided with an antistatic layer on at least one face thereof, the antistatic layer being formed of a metallic thin film or synthetic resin containing a metallic component or a conductive polymer.

7. The privacy securing film as claimed in claim 1, wherein a non-gloss coat layer is provided on at least one face of the hard coat layer such that the privacy securing film has a surface glossiness of less than 85 unit.

8. The privacy securing film as claimed in claim 1, wherein the process of manufacturing the louver film further comprises the step of laminating a radio-shielding coat layer after the transparent film and the opaque adhesive ink layer are laminated, the radio-shielding coat layer being formed of a composition comprising 60 to 80 wt % of carbon paste and 0.01 to 0.1 wt % of fine metallic particles.

9. The privacy securing film as claimed in claim 8, wherein the radio-shielding coat layer is formed in such a way that the composition is repeatedly coated with a thickness of 0.01 to 0.015 mm one to six times.

10. The privacy securing film as claimed in claim 8, wherein the metallic particles are nanosized particles of at least one selected from the group consisting of silver, gold, and copper.

11. The privacy securing film as claimed in claim 9, wherein the metallic particles are nanosized particles of at least one selected from the group consisting of silver, gold, and copper.
